(19) United States
(12) Patent Application Publication
(10) Pub. No.: US 2026/0038140 A1
(43) Pub. Date: Feb. 5, 2026

(54) Probe Pose Determination

(71) Applicant: UCL Business LTD, London (GB)

(72) Inventors: Nina MONTAÑA BROWN; Matthew CLARKSON

(21) Appl. No.: 19/101,219

(22) PCT Filed: Aug. 2, 2023
(86) PCT No.: PCT/GB2023/052045

§ 371 Date: Feb. 4, 2025

(30) Foreign Application Priority Data
Aug. 5, 2022 (GB) 2211486.2

(51) Int. Cl. G06T 7/70; G06T 7/11

(52) U.S. Cl. CPC G06T 7/70; G06T 7/11; G06T 2207/10016; G06T 2207/10132; G06T 2207/20084; G06T 2207/30004; G06T 2207/30244

(57) ABSTRACT

A computer-implemented method for determining a pose of a probe with respect to volumetric scan data is provided. The method comprises receiving image data obtained from a first probe and a second probe. The method also comprises determining, using a machine learning algorithm, a pose of at least one of the first probe and the second probe relative to the volumetric scan data, from the image data. The first probe is or comprises a video camera. The second probe is located at least partially within the field of view of the video camera.

### FIELD OF THE INVENTION

The invention relates to determining a pose of a probe with respect to volumetric scan data, and in particular but not exclusively to determining a pose of at least one of a video camera and another probe (for example an ultrasound probe) with respect to CT or MRI scan data.

### BACKGROUND

Image guidance has been proposed as a technology to facilitate surgeries such as laparoscopic liver resections, which result in less trauma to the patient, reduced post-operative pain and shorter recovery times than an open approach.

Accurate guidance necessitates the spatial alignment of the pre-operative features to the intra-operative data, which conventionally has been approached, for example, via a video to CT or laparoscopic ultrasound (LUS) to CT registration.

However, registration in surgical settings such as laparoscopic liver resection is challenging due to several factors. The imaging probes (e.g., video and LUS) need to be sufficiently small (for example, to fit through a trocar), and typically have limited ranges of motion, resulting in small acquisition ranges in both imaging modalities. Additionally, the smoothness of the liver surface and relative sparseness of features in LUS results in poorly constrained and non-unique registration problems.

Registration algorithms to register a single 2D image (e.g., video or LUS) to a 3D model (e.g., CT or MRI) typically require additional hardware and calibration processes, such as optical or electromagnetic trackers and hand-eye calibration. Existing direct methods that avoid such hardware or calibration processes are challenging and unreliable.

Furthermore, the scalable collection of large databases of tracked data in a surgical setting is logistically challenging, which has precluded the adoption of supervised registration methods in this field. Previous work has partially overcome some of those limitations by constraining the registration search space. For example, restricting the possible initial camera orientations, imposing kinematic constraints between subsequent LUS slices, or compounding subsets of 2D intra-operative data into 2D representations of the scene using tracking devices can result in clinically relevant, initial rigid solutions. However, the lack of commercially available electromagnetically tracked LUS probes have made a 3D LUS-CT registration solution impractical.

The present invention has been devised with the foregoing in mind.

### SUMMARY

According to a first aspect there is provided a computer-implemented method for determining a pose of a probe with respect to volumetric scan data. The method may comprise receiving image data obtained from a first probe and a second probe. The method may also comprise determining, using a machine learning algorithm, a pose of at least one of the first probe and the second probe relative to the volumetric scan data, from the image data. The first probe may be or comprise a video camera. The second probe may be located at least partially within the field of view of the video camera.

Typically in image guided surgery, when registering a 2D video image of an organ to a 3D model of the organ (e.g., determining a pose of the video camera relative to the 3D model), information from inside the organ is not available. Conversely, when registering a 2D ultrasound scan of an organ to a 3D model of the organ (e.g., determining a pose of the ultrasound probe relative to the 3D model), information relating to the surface of the organ is not available.

Using image data from a video camera in which a second probe (e.g., an ultrasound probe) is visible (e.g., located at least partially within the field of view of the video camera) may ensure the image data from the video camera and from the second probe is linked. The image data from the video camera may provide information about an overall position of the organ surface, while the image data from the second probe may constrain angles of rotation by simultaneously aligning internal structures (e.g., blood vessels) of the organ. The combination of both 2D imaging modalities may be more reliable for pose determination of the video camera and the second probe than using either 2D imaging modality alone, and may also reduce or remove the need for tracking and calibration devices.

The method may comprise concatenating the image data from the first probe and the second probe. The method may also comprise determining a pose of at least one of the first probe and the second probe from the concatenated image data.

Determining the pose may comprise determining at least one of a position and an orientation of the respective probe.

The machine learning algorithm may comprise a first path configured to determine a pose of the first probe and a second path configured to determine a pose of the second probe.

The machine learning algorithm may comprise a neural network. The neural network may be or comprise a convolutional neural network.

The image data from at least one of the first probe and the second probe may be segmented. The image data may be segmented to identify one or more objects of interest.

The volumetric scan data and the image data from the first probe and the second probe may be of an organ. The organ may be one of a liver, a kidney and a pancreas.

Image data from the first probe may be segmented to identify at least a part of the organ and/or at least a part of the second probe. Additionally or alternatively, image data from the second probe may be segmented to identify one or more internal structures of the organ, for example one or blood vessels of the organ.

The second probe may be or comprise an ultrasound probe. The ultrasound prove may be or comprise a laparoscopic ultrasound probe or an endoscopic ultrasound probe.

The method may comprise displaying image data from at least one of the first probe and the second probe overlaid on the volumetric scan data.

The machine learning algorithm may be trained using synthetic image data for each of the video camera and the second probe. The synthetic image data may be generated from the volumetric scan data. The synthetic image data may be generated from pre-defined pose data for each of a synthetic video camera and a synthetic second probe relative to the volumetric scan data.

According to a second aspect there is provided a non-transitory computer program comprising instructions for causing a processor to perform the method of the first aspect, including any of the optional features thereof.

According to a third aspect there is provided a computer-readable medium having the computer program of the second aspect stored thereon.

According to a fourth aspect there is provided an apparatus comprising a processor configured to perform the method of the first aspect, including any of the optional features thereof.

The apparatus may further comprise a first probe and a second probe. The first probe may be or comprise a video camera. The second probe may be or comprise an ultrasound probe. The ultrasound probe may be or comprise a laparoscopic ultrasound probe or an endoscopic ultrasound probe.

The apparatus may further comprise a display. The processor may be configured to control or cause the display to display image data from at least one of the first probe and the second probe overlaid on the volumetric scan data.

According to a fifth aspect, there is provided a computer-implemented method of training the machine learning algorithm of the first aspect. The method may comprise generating initial synthetic image data in respect of each of the video camera and the second probe. The method may also comprise determining predicted pose data for each of the video camera and the second probe from the initial synthetic image data. The method may further comprise training the machine learning algorithm using a pose-based loss function.

The pose-based loss function may determine a pose loss between the predicted pose data and pre-defined pose data used to generate the initial synthetic image data.

The pose-based loss function may comprise a rotation loss component and a translation loss component.

The pose-based loss function may be defined as

$${ℒ}_{POSE} = λ {‖ {t}^{′} - \hat{t} ‖}_{2} + μ ( 1 - \frac{{q}^{′} \cdot \hat{q}}{‖ {q}^{′} ‖ ‖ \hat{q} ‖} ) ,$$

wherein t′ and \hat{t} are ground-truth and predicted normalised translation vectors respectively, q′ and \hat{q} are ground-truth and predicted unit quaternions respectively, and λ and μ are weighting terms for translation and rotation components of the loss respectively.

The method may further comprise re-rendering synthetic image data for each of the video camera and the second probe from the predicted pose data. The method may also comprise training the machine learning algorithm using an image-based loss function.

The image-based loss function may define an image loss between the re-rendered synthetic image data and the initial synthetic image data.

The image-based loss function may calculate a voxel-wise image loss. The image-based loss function may be defined as

$${ℒ}_{IM} = \frac{1}{\vert 𝒥 \vert} {‖ 𝒥 - \hat{𝒥} ‖}_{2} ,$$

wherein [symbol] and [symbol] are the initial synthetic image data and re-rendered synthetic image data respectively.

The method may comprise training the machine learning algorithm using a combination of the pose-based loss function and the image-based loss function, for example a sum of the pose-based loss function and the image-based loss function. The combination may be or comprise a weighted combination of the pose-based loss function and the image-based loss function, for example a weighted sum.

The method may comprise training the machine learning algorithm using a total training loss weighted over the sum of the pose loss and image loss for each of the video camera and the second probe respectively. The respective image loss for each of the video camera and the second probe may comprise an additional weighting factor.

The combination of the pose-based loss function and the image-based loss function may define a total loss function

$$ℒ = α ( γ {ℒ}_{IM}^{vid} + {𝒥}_{POSE}^{vid} ) + β ( γ {ℒ}_{IM}^{us} + {ℒ}_{POSE}^{us} ) ,$$

wherein α, β, γ are scalar values.

The initial synthetic image data may be generated from volumetric scan data. The initial synthetic image data may be generated from pre-defined pose data for each of a synthetic video camera and a synthetic second probe relative to the volumetric scan data.

Features which are described in the context of separate aspects and embodiments of the invention may be used together and/or be interchangeable wherever possible. Similarly, where features are described in the content of a single aspect or embodiment for brevity, those features may also be provided separately or in any suitable sub-combination. Features described in connection with the method of the first aspect may have corresponding features definable with respect to the computer program, computer-readable medium, apparatus or method of the second, third, fourth and fifth aspects respectively, and vice versa, and those embodiments are specifically envisaged.

### BRIEF DESCRIPTION OF THE DRAWINGS

Embodiments will now be described, purely by way of example, with reference to the accompanying drawings, in which:

FIG. 1 shows a method for determining a pose of a probe with respect to volumetric scan data in accordance with an embodiment of the invention;

FIG. 2 shows an apparatus for determining a pose of a probe with respect to volumetric scan data in accordance with an embodiment of the invention;

FIG. 3 shows a surgical scene containing a model (derived from volumetric scan data) of a patient's liver, and a synthetic camera and synthetic laparoscopic ultrasound (LUS) probe in model space:

FIG. 4 shows an example of a rendering pipeline for generating synthetic data to train a machine learning algorithm for use in the method and apparatus shown in FIGS. 1 and 2 respectively:

FIG. 5 shows an example of a training pipeline for training a machine learning algorithm for use in the method and apparatus shown in FIGS. 1 and 2 respectively:

FIG. 6 shows an example of a machine learning algorithm for use in the method and apparatus shown in FIGS. 1 and 2 respectively:

FIGS. 7A and 7B shows results obtained for versions of the machine learning algorithm shown in FIG. 6 trained using different hyperparameters:

FIGS. 7C and 7D show an example registration and re-rendering of video and LUS image data from pose estimations of unseen synthetic test data, made by a machine learning algorithm trained using the best performing hyperparameters from FIGS. 7A and 7B:

FIGS. 8A and 8B shows results obtained by for pose determination for input image renderings to which simulated noise is applied, made by machine learning algorithms trained using the best performing hyperparameters from FIGS. 7A and 7B and using different combinations of synthetic features:

FIGS. 9A and 9B shows an example registration and re-rendering of video and LUS image data from pose estimations of real patient data, made by a machine learning algorithm in accordance with an embodiment of the invention.

### DETAILED DESCRIPTION

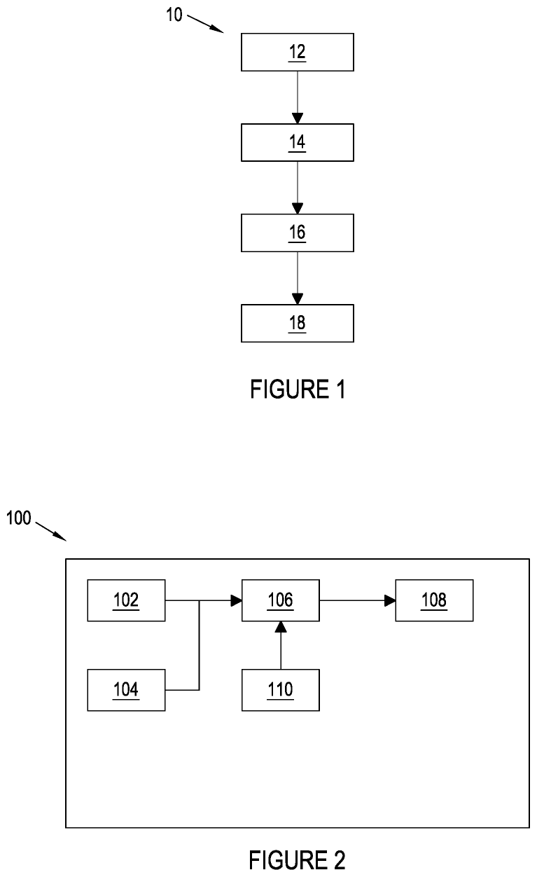

FIG. 1 shows a method 10 for determining a pose of a probe with respect to volumetric scan data, in accordance with an embodiment of the present invention.

At step 12 image data obtained from a first probe and a second probe is received. The first probe is or comprises a video camera. The second probe is located at least partially within the field of view of the video camera. In the embodiment shown, the second probe is or comprises an ultrasound probe, although that is not essential.

Optionally, at step 14, the image data from the first probe and the second probe is concatenated.

At step 16 a pose of at least one of the first probe and the second probe relative to volumetric scan data is determined, using a machine learning algorithm, from the image data. In the embodiment shown, the volumetric scan data is or comprise CT scan data, although that is not essential. Other forms of volumetric scan data may alternatively be used, for example MRI scan data. In the embodiment shown, the machine learning algorithm is or comprises a neural network (for example a convolutional neural network), although that is not essential and a different machine learning algorithm may alternatively be used. Determining the pose of the probe may comprise determining at least one of a position and an orientation of the respective probe.

Optionally, at step 18, the image data from the at least one of the first probe and the second probe is displayed overlaid on the volumetric scan data. That may provide an augmented-reality (AR) display that enhances or improves a user experience, for example enabling image-guided surgery using intra-operative video image data and ultrasound data overlaid on pre-operative volumetric scan data obtained from a patient.

FIG. 2 shows an apparatus 100 for determining a pose of a probe with respect to volumetric scan data, in accordance with an embodiment of the present invention.

The apparatus 100 comprises a first probe 102, a second probe 104, a processor 106 and a display 108.

The first probe 102 is or comprises a video camera. In the embodiment shown, the second probe 104 is or comprises an ultrasound probe (for example a laparoscopic ultrasound probe or an endoscopic ultrasound probe), although that is not essential, and a different type of probe configured to obtain 2D image data may alternatively be used.

The processor 106 is configured to receive image data obtained from the first probe 102 and the second probe 104. The processor 106 may also be in communication with a memory 110 storing volumetric scan data. The processor 106 comprises a machine learning algorithm configured to determine, from the image data, a pose of at least one of the first probe 102 and the second probe 104. The machine learning algorithm may be configured to determine at least one of a position and an orientation of the at least one probe 102, 104. In the embodiment shown, the machine learning algorithm is or comprises a neural network (for example a convolutional neural network), although that is not essential, and a different machine learning algorithm may alternatively be used.

The processor 106 may be further configured to cause the display 108 to display the image data from the at least one of the first probe 102 and the second probe 104 overlaid on the volumetric scan data. The processor 106 may also be configured to register the image data to the volumetric scan data based on the determined pose of the at least one probe 102, 104, to cause the display 108 to provide an augmented-reality display.

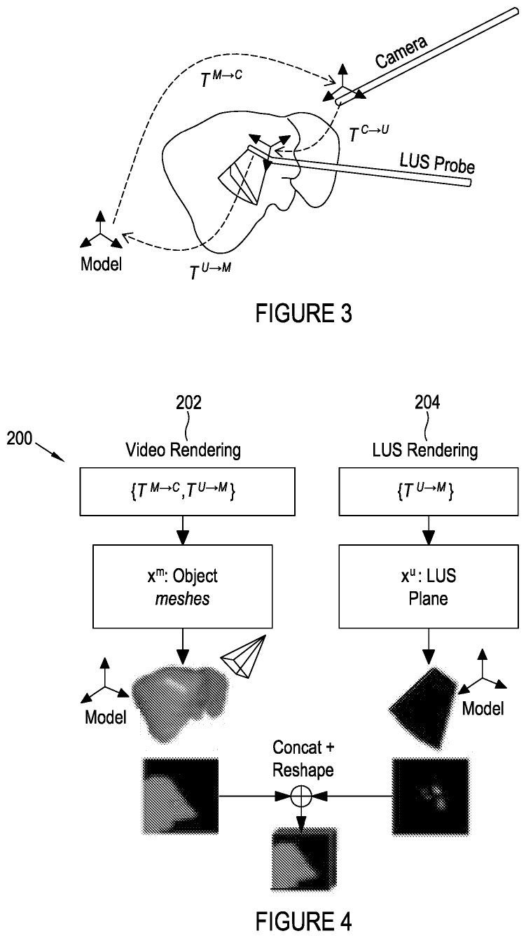

Example embodiments of the present are described in more detail below with reference to FIGS. 3 to 9, which relate to laparoscopic liver surgery. It will be appreciated that the present invention may equally be applied to other types of procedure (for example, endoscopic procedures such as screening, or biopsy procedures) and/or on a different organ of interest (for example, kidney or pancreas), or equally to applications other than medical procedures that require determining the pose of at least one probe with respect to volumetric scan data.

FIG. 3 shows a surgical scene containing a model (e.g., volumetric scan data) of a patient's liver, and a synthetic camera and synthetic laparoscopic ultrasound (LUS) probe in model space. The relation in space between the model, camera and LUS probe is established by placing them in a scene. Given a set of transforms describing the position of each of the model, camera and LUS probe in space, a view from each of the camera and LUS probe can be rendered. A machine learning algorithm can then be trained to predict poses of the camera and the LUS probe from the rendered images.

FIG. 4 shows an example of a rendering pipeline 200 for generating synthetic training data to train a machine learning algorithm for use in the method 10 and the apparatus 100 described above. The rendering pipeline 200 comprises a video rendering module 202 and a laparoscopic ultrasound (LUS) rendering module 204.

Three homogeneous spaces are defined for a model [symbol] , camera [symbol] and ultrasound [symbol] , where { [symbol] }⊂ [symbol] ⁴. x^{m}∈ [symbol] , x^{c}∈ [symbol] and x^{u}∈ [symbol] define coordinates in the corresponding coordinate systems.

In the example video rendering module 202 shown, a homogeneous rigid transformation T^{m→c} that maps model space [symbol] to camera space [symbol] , x^{c}=T^{m→c}x^{m} can be used in conjunction with a projective transformation K to model the camera imaging processes. The camera intrinsics K can be used to generate model coordinates in an image, x^{vid}=KT^{m→c}x^{m}, where x_{vid}∈ [symbol] ⊂ [symbol] ³ are the coordinates in the video image space [symbol] . The appearance of the surgical scene in a laparoscopic video image [symbol] _{vid}(x^{vid}) may therefore be obtained through the sampling of N coordinate positions

$${x}^{vid} = \{ {x}_{i}^{vid} \vert i ∈ I \} ,$$

where

$$I = \{ 1 , 2 , … , N \} via {x}_{i}^{vid} = {KT}^{m \to c} {x}_{i}^{m} .$$

In the example LUS rendering module 204 shown, laparoscopic ultrasound (LUS) images

$${𝒥}_{u s} ( {x}^{u} ) , {x}^{u} = \{ {x}_{j}^{u} \vert j ∈ J \} ,$$

where J={1, 2, . . . , M}, can be generated by synthetically re-sampling vessel features at locations

$${x}_{j}^{m} = {T}^{u \to m} {x}_{j}^{u}$$

representing arbitrarily oriented ultrasound planes in the model space [symbol] given x^{u}, which represents image grid locations in the ultrasound space [symbol] .

Soft-rasterization of mesh models may be used to obtain synthetic video images [symbol] _{vid}(x^{vid}) containing the liver silhouette and the probe silhouette, and bilinear interpolation may be used to obtain synthetic LUS images [symbol] _{LUS}(x^{u}) with binary vessel features rendered in the image. However, that is not essential, and it will be appreciated any suitable rendering approach may alternatively be used. The rendering pipeline may be differentiable and implemented using open-source libraries. The rendering modules 202, 204 are configured to render the synthetic video images and synthetic LUS images to dimensions matching an expected size of real images that would be obtained from the video camera and LUS probe respectively, although that is not essential. The rendered images are then each resampled to 200×200 pixels, although any suitable resampling size may alternatively be used. It will be appreciated real images from the video camera and LUS probe may also be resampled to the same resampled image size as the synthetic images used to train the machine learning algorithm.

Prior to training the machine learning algorithm, a reference pose of the camera T_{m→c} and of the LUS probe T_{u→m} may be empirically pre-defined with respect to the liver model such that the LUS probe is located on the surface of the liver model, and the camera is placed simulating a view from a singular trocar pointing towards the LUS probe and liver surface, as depicted in FIGS. 3 and 4. During training, new poses may be generated by applying perturbations on the original, pre-defined poses, for example by sampling uniformly distributed, mean-centered, isotropic 3D translation and Euler angle rotation perturbation spaces defined by ranges δₜ, δᵣ respectively. Alternatively, a different approach may be used to accommodate a wider range of poses, for example substantially all poses of the LUS probe on the surface of the liver model and substantially all poses of the video camera pointing towards the LUS probe and liver surface. That may be based on positions and/or normals on the surface of the liver model, without requiring pre-defined reference poses to be provided. For example, sampling (e.g., uniform sampling) may be employed over substantially the full parameter space of poses (e.g., poses over the whole surface of the liver model subject to a constraint on plausible perturbations in position and orientation), or over a probability distribution function of potential poses over the whole surface of the liver model.

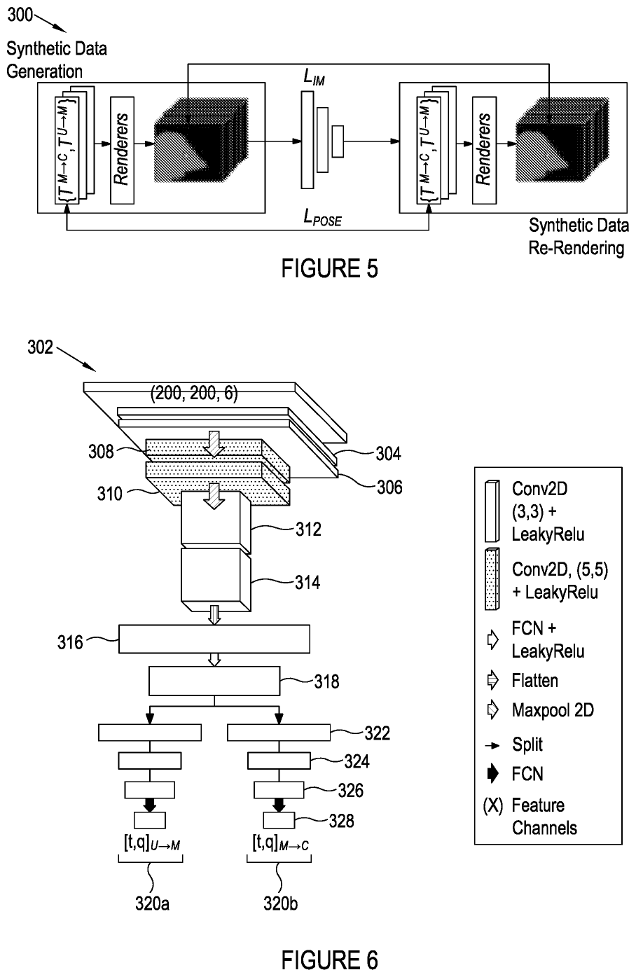

FIG. 5 shows an example of a training pipeline 300 for training a machine learning algorithm 200 for use in the method 10 and the apparatus 100 described above.

Pairs of poses describing the camera and the LUS probe, {T^{m→c},T_{u→m}}, can be generated and used to render a set of images [symbol] ={ [symbol] _{vid}, [symbol] _{LUS}}, for example using the rendering pipeline 200 described above. The set of images [symbol] may be used as inputs to a machine learning algorithm 302 to regress the corresponding poses, T^{m→c} and T^{u→m} The poses may be regressed in their vector forms

$${[ {t}_{vid}^{T} , {q}_{vid}^{T} ]}^{T} {and [ {t}_{u s}^{T} , {q}_{u s}^{T} ]}^{T}$$

respectively, where t are normalised translation vectors and q are unit quaternions, although that is not essential.

In the example shown, image data from the rendered images from each respective pair of poses may be concatenated prior to being input into the machine learning algorithm 302 for training, although that is not essential, and image data from the rendered images may not be concatenated, and may be input separately into the machine learning algorithm 302 (discussed further below).

In the example shown, the concatenated image data has dimensions of 200×200×6 pixels, although any suitable dimensions may alternatively be used. The depth of 6 pixels represents the 3 RGB colour channels for each of the video camera and the LUS probe respectively. In the image data from the rendered video camera image, the LUS probe silhouette is rendered in the green channel, and the liver silhouette is rendered in the red channel (effectively leaving an empty blue channel). In the image data from the rendered LUS probe image, the hepatic vein is rendered in the green channel and the portal vein is rendered in the blue channel. The features of interest in the respective rendered images are therefore binarised, as discussed above. However, that is not essential. For example, alternative methods may use 3D rendering to obtain realistic 3D images from the video camera. The images are then concatenated feature wise.

A loss function [symbol] _{POSE} on the output of the machine learning algorithm 302 may then be used to train the machine learning algorithm 302 from its predictions. The loss function [symbol] _{POSE} may be defined as

$${ℒ}_{POSE} = λ {‖ {t}^{′} - \hat{t} ‖}_{2} + μ ( 1 - \frac{{q}^{′} \cdot \hat{q}}{‖ {q}^{′} ‖ ‖ \hat{q} ‖} )$$

where ∥⋅∥₂ is the L²-norm between the predicted \hat{t} and ground-truth labels t′, whilst the following terms describes the cosine distance between the predicted quaternions \hat{q} and ground-truth q′. In the example shown, two hyperparameters λ and μ weight the translation and rotation components of the loss respectively, although that is not essential. It will be appreciated other pose-based loss functions may alternatively be used.

Using pose-based loss functions can require careful rotation loss weight tuning for maximal performance. An additional image-based loss function may optionally be incorporated into the training pipeline by re-rendering the scene from the predicted poses of the camera and the LUS probe, for example using the rendering pipeline 200 described above. A loss function [symbol] _{IM} may then be used to calculate a voxel-wise image loss. The loss function [symbol] _{IM} may be defined as

$${ℒ}_{IM} = \frac{1}{\vert 𝒥 \vert} {‖ 𝒥 - \hat{𝒥} ‖}_{2}$$

where [symbol] is the predicted pose-rendered images.

A complete training loss may then be weighted over the video and LUS pose and image losses, for example using scalar values α and β respectively. The image losses may also be weighted by a factor γ, such that the final loss may be defined as

$$ℒ = α ( {γℒ}_{IM}^{vid} + {ℒ}_{POSE}^{vid} ) + β ( {γℒ}_{IM}^{us} + {ℒ}_{POSE}^{us} )$$

where the superscripts vid and us indicate the contributions from video and LUS data to the loss.

It will be appreciated any suitable training approach may alternatively be used to train the machine learning algorithm 302 for use in the method 10 and the apparatus 100 described above.

FIG. 6 shows an example of machine learning algorithm 302 in more detail. The machine learning algorithm 302 comprises a convolutional neural network (CNN). The concatenated image data from the camera and LUS probe is provided to a first convolution layer 304. The first convolution layer 304 is a 2D convolution layer configured to produce one or more feature maps from the concatenated image data, although that is not essential. The number of feature maps produced may be equal to the number of filters in the first convolution layer 304. In the example shown, the first convolution layer 304 comprises 12 filters, although a different number of filters may alternatively be used. The kernel of each filter in the first convolution layer 306 has a size of 5×5 pixels, although any suitable kernel size may alternatively be used. The kernels are used with a step size of 1, although any suitable step size may alternatively be used. The first convolution layer 304 comprises a Leaky Relu activation function, although any suitable activation function may alternatively be used such as the sigmoid function, exponential function, ReLu etc.

The feature maps produced by the first convolution layer 304 are provided to a second convolution layer 306. In the example shown, the second convolution layer 306 is substantially similar to the first convolution layer 304. The second convolution layer 306 comprises 12 filters, although a different number of filters may alternatively be used.

A first 2D maxpooling operation is performed on each of the feature maps produced by the second convolution layer 306, to reduce dimensionality of the feature maps. The kernel of the maxpooling operation may have any suitable size and stride.

The reduced dimension feature maps output from the first 2D maxpooling operation are provided to a third convolution layer 308. The third convolution layer 308 is a 2D convolution layer configured to produce one or more feature maps, similar to the first and second convolution layers 304, 306. The third convolution layer 308 comprises 24 filters, although any suitable number of filters may alternatively be used. The kernel of each filter in the third convolution layer 308 has a size of 3×3 pixels, although any suitable kernel size may alternatively be used. The kernels are used with a step size of 1, although any suitable step size may alternatively be used. The third convolution layer 308 comprises a Leaky Relu activation function, although any suitable activation function may alternatively be used such as the sigmoid function, exponential function, ReLu etc.

The feature maps produced by the third convolution layer 308 are provided to a fourth convolution layer 310. In the example shown, the fourth convolution layer 310 is substantially similar to the third convolution layer 308. The fourth convolution layer 310 comprises 24 filters, although a different number of filters may alternatively be used.

A second 2D maxpooling operation is performed on each of the feature maps produced by the fourth convolution layer 310, to reduce dimensionality of the feature maps. The kernel of the maxpooling operation may have any suitable size and stride.

The reduced dimension feature maps output from the second 2D maxpooling operation are provided to a fifth convolution layer 312. The fifth convolution layer 312 is a 2D convolution layer configured to produce one or more feature maps, similar to the preceding convolution layers 304, 306, 308, 310. The third convolution layer 312 comprises 48 filters, although any suitable number of filters may alternatively be used. The kernel of each filter in the fifth convolution layer 312 has a size of 3×3 pixels, although any suitable kernel size may alternatively be used. The kernels are used with a step size of 1, although any suitable step size may alternatively be used. The fifth convolution layer 312 comprises a Leaky Relu activation function, although any suitable activation function may alternatively be used such as the sigmoid function, exponential function, ReLu etc.

The feature maps produced by the fifth convolution layer 312 are provided to a sixth convolution layer 314. In the example shown, the sixth convolution layer 314 is substantially similar to the fifth convolution layer 312. The sixth convolution layer 314 comprises 48 filters, although a different number of filters may alternatively be used.

A flattening operation is performed on the feature maps produced by the sixth convolution layer 314 to transform the data into a 1D layer 316. In the example shown, the 1D layer comprises a 1D vector having 122288 channels, although the flattening operation may alternatively produce a 1D layer having any suitable number of channels. The 1D layer 316 comprises a Leaky Relu activation function, although any suitable activation function may alternatively be used such as the sigmoid function, exponential function, ReLu etc.

The 1D layer 316 is connected to a first fully connected layer 318. In the example shown, the first fully connected layer 318 comprises 3000 nodes or channels, although any suitable number of channels or nodes may alternatively be used.

After the first fully connected layer 318, the network splits into two different paths 320a, 320b such that the first fully connected layer 318 is separately connected to each of the paths 320a, 320b. Each path 320a, 320b comprises a series of fully connected layers 322-328. In the example shown, each path 320a, 320b comprises four fully connected layers 322, 324, 326, 328, although any suitable number of fully connected layers may alternatively be used. The first fully connected layer 322 of each path 320a, 320b comprises 1500 channels, the second fully connected layer 324 of each path 320a, 320b comprises 1000 channels, the third fully connected layer 326 of each path 320a, 320b comprises 100 channels and the fourth fully connected layer 328 of each path 320a, 320b comprises 7 channels. However, each path 320a, 320b may comprise any suitable number of fully connected layers 322-328 each having any suitable number of channels.

The output of the final fully connected layer 328 of the first path 320a is the predicted pose of the LUS probe, and the output of the final fully connected layer 328 of the second path 320b is the predicted pose of the video camera. In the example shown, the poses are regressed in their vector form as described above, although that is not essential.

Alternatively, the machine learning algorithm 302 may have a different architecture to that described above. For example, the machine learning algorithm 302 may have a conventional CNN architecture without separate paths for regressing the poses of the video camera and the LUS probe respectively, and may instead have a single pathway which provides predicted poses for both the video camera and the LUS probe simultaneously. The machine learning algorithm 302 may equally have any suitable architecture other than a CNN architecture.

Image data from the separate synthetic video and LUS images for each respective pair of poses may alternatively be input separately input into the machine learning algorithm 302, without being concatenated. Additionally or alternatively, different convolution filters may be separately applied to the image data from the rendered images for each imaging modality in at least one convolution layer, rather than applying the same convolution filters to the image data from both rendered images at each convolution layer.

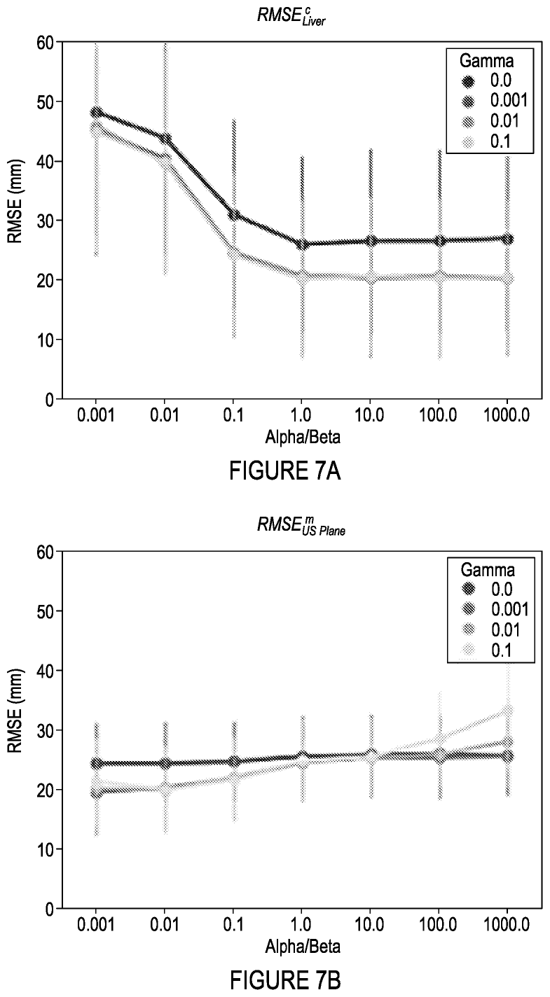

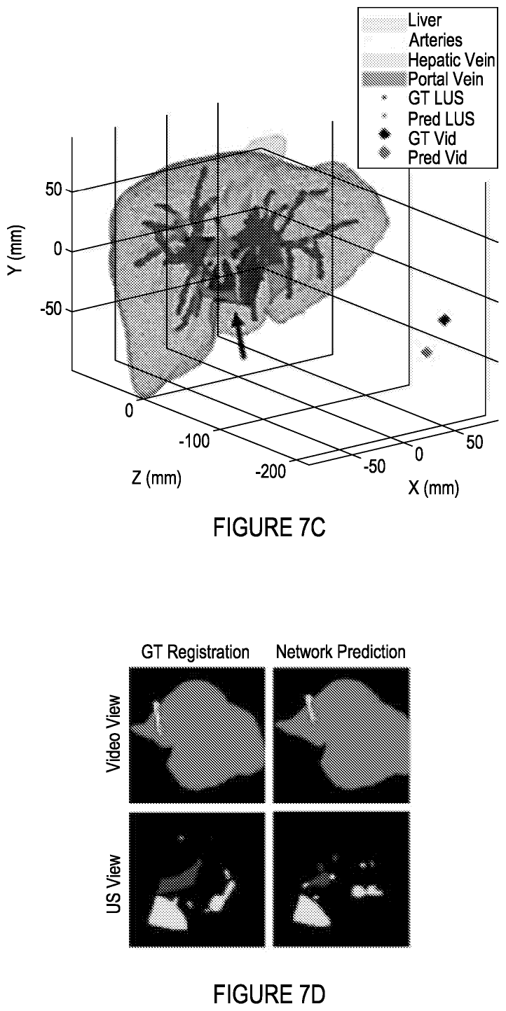

FIGS. 7 to 9 show experimental results obtained using trained versions of the machine learning algorithm 302 (“model” 302) described above.

Each version of the model 302 was trained in accordance with the training pipeline 300 described above. Each version of the model 302 was trained using mini-batch gradient descent with 10 steps per epoch, an Adam optimizer (LR=10⁻⁴, weight decay=0.1 every 300 epochs) for 3000 epochs and a batch size of 5 on a single NVIDIA Tesla V100 GPU, although that is not essential.

The camera LUS probe translation ranges were set at

$${δ}_{t}^{vid} = \pm 80 mm ,$$

$${δ}_{t}^{LUS} = \pm 20 mm ,$$

$$and$$

$${δ}_{r}^{vid} , {δ}_{r}^{LUS} = \pm 20 ° ,$$

although that is not essential. The translation components of the perturbed poses were normalized to lie within a 500 mm mean-centred cube in model space. The performance was evaluated by measuring the root mean square error (RMSE) between mesh coordinates transformed by the predicted and ground-truth parameters. The RMSE was evaluated over liver model mesh coordinates camera space

$$𝒞 ( {RMSE}_{Liver}^{C} ) ,$$

LUS probe model mesh coordinates in model space

$$ℳ ( {RMSE}_{Probe}^{M} ) ,$$

and in the case of the LUS plane, the error was evaluated over the synthetic plane corner coordinates in model space

$$ℳ ( {RMSE}_{LUS Plane}^{M} ) .$$

All models were evaluated over a randomly sampled, fixed, test set composed of 2500 poses, although a different number of test poses may alternatively be used.

The trained models 302 were evaluated against a single, patient-specific CT dataset. Liver surface, hepatic vein, portal vein and artery models were extracted from a contrast-enhanced CT scan, and a CAD model of a LUS probe (BK Medical I12C4F (9066) in the example shown, although any suitable probe may alternatively be used) was obtained for the simulation of the LUS probe appearance. A calibration matrix K was obtained to simulate views from a video camera (Karl Storz 3D TIPCAM laparoscope in the example shown, although any suitable video camera may alternatively be used such as an endoscopic camera), calibrated through standard calibration techniques (any suitable calibration approach may be used).

In a first experiment, the impact of ablating and varying the weights {α, β, γ} on pose determination and registration performance was explored by training sets of models 302 with variations of loss weightings, for example such that

$$\frac{α}{β} ∈ \{ {10}^{- 3} , {10}^{- 2} , {10}^{- 1} , 1 , {10}^{1} , {10}^{2} , {10}^{3} \} , γ ∈ \{ 0 , {10}^{- 1} , {10}^{- 2} , {10}^{- 3} \}$$

and empirically set {λ=1, μ=20} for all models 302. The best set of hyperparameters were found by performing two-sided t-tests with Bonferroni corrected p-values (α<2×10⁻³) between different models' 302 RMSE distributions at inference, although that is not essential.

As shown in FIGS. 7A and 7B, the RMSE for the liver model (FIG. 7A) and synthetic vessel plane (FIG. 7B) for each model 302 trained with varying values of α/β and γ were plotted.

FIGS. 7C and 7D also show an example registration (FIG. 7C) and re-rendering of model 302 predictions (FIG. 7D) on unseen test data for the model 302 trained using the best set of hyperparameters as discussed above. The camera RMSE error was 24 mm, whilst the LUS RMSE error was 10 mm. The black arrow in FIG. 7C points at the overlap between the ground truth and predicted LUS planes in 3D.

All models 302 trained with an image loss (γ>0) result in statistically significantly better performance than models 302 trained with no image loss in the case of camera pose estimation, and statistically significantly better performance is obtained for all models 302 with pose weighting

$$\frac{α}{β} \leq 1.$$

for LUS plane registration. It was additionally found that as α increases, all models' 302 pose determination and registration of the liver (e.g., camera pose) improves and becomes less variable, whereas increasing β results in a better performance of the models 302 in respect of LUS plane registration (e.g., LUS probe pose). The lowest, mean RMSE over both camera pose determination and LUS probe pose determination resulted from hyperparameters γ=10⁻¹ and

$$\frac{α}{β} = 1 {0}^{- 1} .$$

In a second experiment, models 302 were trained to perform single or multiple pose regression with different combinations of synthetic features. The synthetic features used were the silhouette rendering of the liver (“Liver”) and the silhouette rendering of the probe model (“probe”) from the laparoscopic camera (as described above), and the LUS plane rendering (“LUS”). The model weight hyperparameters α, β, γ to the best performing hyperparameters obtained from the first experiment described above

$$( γ = 1 {0}^{- 1} and \frac{α}{β} = 1 {0}^{- 1} )$$

for multiple pose regression, whilst setting α=β=1 for single pose regression.

The mean and standard deviation in RMSE for each model was determined, the values of which are shown in Table 1 below. Bold values indicate the best mean performance for each feature registration/pose determination.

TABLE 1
Table showing Mean (Standard Deviation) of RMSE (mm) for models 302
trained to regress single or multiple poses from different combinations
of synthetic features.

| | | RMSE (mm) | | |
|---|---|---|---|---|
| | | ${RMSE}_{Liver}^{C}$ | ${RMSE}_{Probe}^{M}$ | ${RMSE}_{LUS Plane}^{M}$ |
| Feature | Liver | 25.6 (15.3) | x | x |
| | LUS | x | x | 14.4 (5.8) |
| | Liver + LUS | 27.6 (15.6) | 20.15 (5.4) | 26.0 (6.4) |
| | Liver + Probe | 36.0 (16.1) | 17.6 (5.6) | 23.4 (6.7) |
| | LUS + Probe | 61.71 (31.8) | 14.05 (5.7) | 17.9 (7.1) |
| | Liver + LUS + Probe | 24.10 (13.34) | 23.68 (6.6) | 21.16 (6.9) |

The lowest RMSE for camera pose estimation results from the model 302 trained on all features, whilst the lowest RMSE on the LUS plane is obtained on the single pose regression network. The highest RMSE for liver registration is observed for the model 302 trained with LUS plane and probe silhouette renderings, which suggests that the liver silhouette rendering is a more informative feature than the probe silhouette rendering to perform camera pose regression.

In a third experiment, the models' 302 robustness to feature corruption in the image space was also tested by simulating noise in unseen test set input image renderings. In the example shown, Gaussian noise σ={0.5, 1, 1.5, 2} mm was applied to the liver surface model vertices, and/or a number of vessel segmentations Nᵥ={1, 2, 3} were deleted from the ultrasound renderings. It will be appreciated noise may alternatively be applied in any suitable manner.

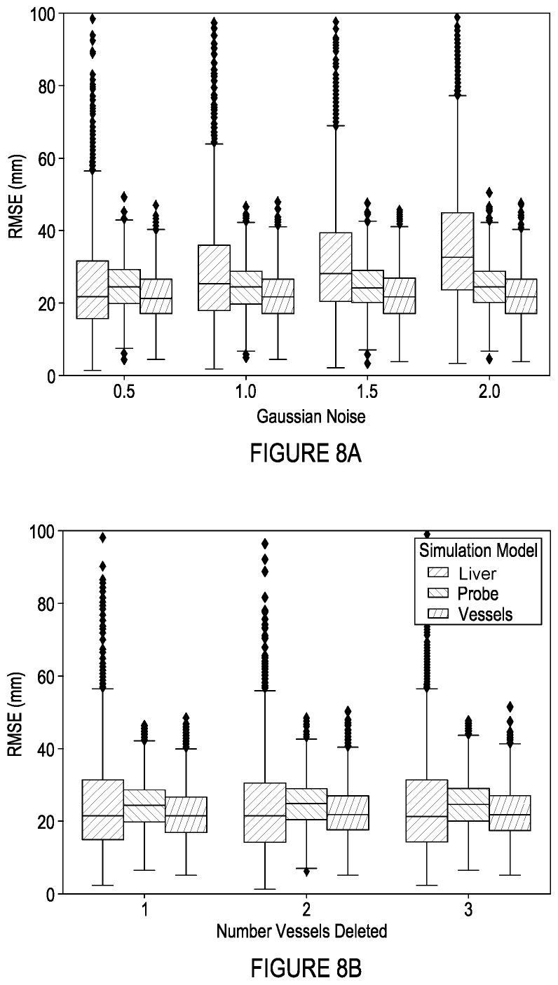

FIG. 8 shows a plot of RMSE error as a function of segmentation noise. An increasing trend in RMSE is observed for the camera pose determination where Gaussian noise is applied to the liver silhouette rendering, increasing from 21 mm to 32 mm with 0.5 mm to 2.0 mm Gaussian noise, respectively (shown in FIG. 8A). No significant change in RMSE on any of the predicted liver model, probe model or vessel plane is observed by deleting up to three vessels from the rendered LUS plane (shown in FIG. 8B). Given the LUS probe rendering from the camera also depends on T_{u→m}, that may suggest the models 302 can jointly rely on the rendering of the vessels and the LUS probe body to predict T_{u→m} despite noise in the LUS image.

In a fourth experiment, a trained model 302 was used for camera and LUS probe pose estimation on real laparoscopic video and ultrasound intra-operative data. The liver surface, LUS probe and LUS vessels were manually segmented from retrospective clinical data. Ground truth registrations were manually obtained for comparison.

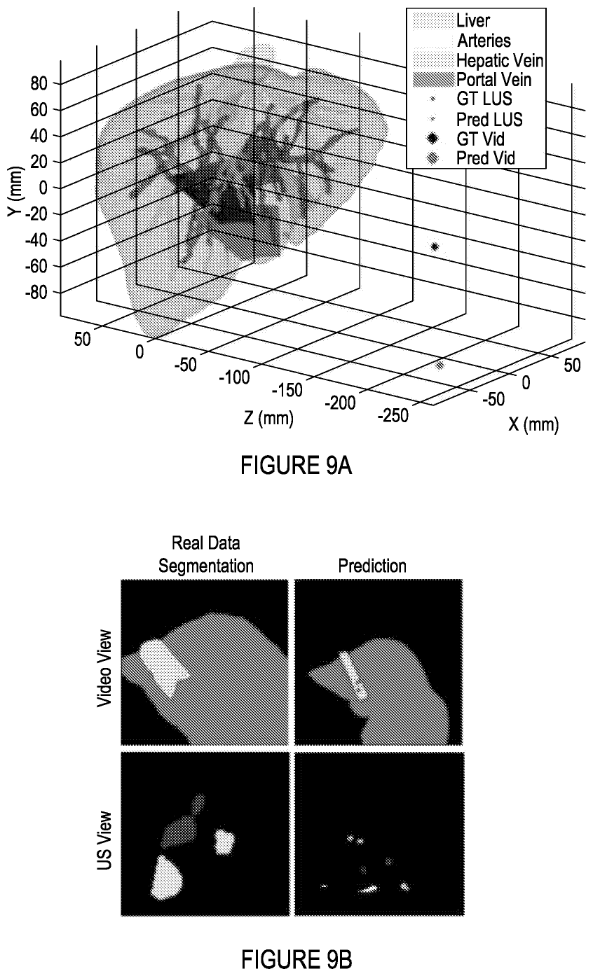

FIG. 9A shows registration of the model 302 predictions with the volumetric scan data, while FIG. 9B shows liver silhouette segmentation, probe silhouette segmentation and vessel segmentation for the manually segmented real data and the rendered model 302 predictions. Compared to the ground truth, the obtained RMSE values were 128.1 mm for camera pose estimation and 36.2 mm for LUS pose estimation.

The above results show that combining image data from a video camera and a second probe (for example, an LUS probe) located at least partially within the field of video of the camera may facilitate and jointly benefit pose estimation or determination for both the camera and the second probe with respect to volumetric scan data, compared to independent pose determinations based on only a single imaging modality. The results also show that may be achieved with synthetically trained machine learning algorithms trained using training data derived from volumetric scan data, reducing the need for large databases of tracked, annotated training data based on real images. That approach may also enable pose determination of the camera and the second probe with respect to volumetric scan data without requiring tracking information and/or tracking apparatus, which may find particular benefit in image-guided surgery. That may reduce the amount of time and/or equipment necessary in surgical procedures.

Although specific embodiments have been described variations are possible within the scope of the invention. The scope of the invention should be determined with reference to the accompanying claims.

1. A computer-implemented method for determining a pose of a probe with respect to volumetric scan data, comprising:
receiving image data obtained from a first probe and a second probe;
determining, using a machine learning algorithm, a pose of at least one of the first probe and the second probe relative to the volumetric scan data, from the image data; wherein
the first probe is or comprises a video camera; and
the second probe is located at least partially within the field of view of the video camera.

2. The method of claim 1, comprising concatenating the image data from the first probe and the second probe; and determining a pose of at least one of the first probe and the second probe from the concatenated image data.

3. The method of claim 1, wherein determining the pose comprises determining at least one of a position and an orientation of the respective probe.

4. The method of claim 1, wherein the machine learning algorithm comprises a first path configured to determine a pose of the first probe and a second path configured to determine a pose of the second probe.

5. The method of claim 1, wherein the machine learning algorithm comprises a neural network, and optionally comprises a convolutional neural network.

6. The method of claim 1, wherein the image data from at least one of the first probe and the second probe is segmented.

7. The method of claim 6, wherein the volumetric scan data and the image data from the first probe and the second probe is of an organ, and optionally wherein the organ is one of a liver, a kidney and a pancreas.

8. The method of claim 7, wherein:
i) image data from the first probe is segmented to identify at least a part of the organ and/or at least a part of the second probe; and/or
ii) image data from the second probe is segmented to identify one or more internal structures of the organ, optionally one or more blood vessels of the organ.

9. The method of claim 1, wherein the second probe is or comprises an ultrasound probe, and optionally is or comprises a laparoscopic ultrasound probe or an endoscopic ultrasound probe.

10. The method of claim 1, comprising displaying image data from at least one of the first probe and the second probe overlaid on the volumetric scan data.

11. A non-transitory computer program comprising instructions for causing a processor to perform the method of claim 1.

12. A computer-readable medium having the computer program of claim 11 stored thereon.

13. An apparatus comprising a processor configured to perform the method of claim 1.

14. The apparatus of claim 13, further comprising a first probe and a second probe, wherein the first probe is or comprises a video camera.

15. The apparatus of claim 14, wherein the second probe is or comprises an ultrasound probe, and optionally is or comprises a laparoscopic ultrasound probe or an endoscopic ultrasound probe.

16. The apparatus of claim 13, further comprising a display, wherein the processor is configured to control the display to display image data from at least one of the first probe and the second probe overlaid on the volumetric scan data.
